(19) United States
(12) Patent Application Publication
(10) Pub. No.: US 2019/0172142 A1
(43) Pub. Date: Jun. 6, 2019

(54) MODEL INVESTMENT PORTFOLIOS AND FUNDS CONTAINING COMBINED HOLDINGS ONLY FOUND IN MANAGED ACCOUNTS WITH THE GREATEST PERFORMANCES BY TIME PERIOD, RISK LEVEL, AND ASSET CLASS; INCLUDING ARTIFICIAL INTELLIGENCE-ENHANCED VERSIONS

(71) Applicant: Dale Sundby, Tucson, AZ (US)

(72) Inventor: Dale Sundby, Tucson, AZ (US)

(21) Appl. No.: 15/829,828

(22) Filed: Dec. 1, 2017

(51) Int. Cl. G06Q 40/06

(52) U.S. Cl. CPC G06Q 40/06

(57) ABSTRACT

Methods and systems for selecting and weighting securities for actively managed model portfolios and funds. Each managed account portfolio's return and consistency performance is measured and ranked by time period, risk level, and/or asset class. The greatest performing in each are backtested in various combinations and weightings. Model portfolios and funds are offered to investors and advisors based on optimal combinations. Additional models and funds are offered which are artificial intelligence-enhanced.

### RELATED APPLICATION

This application claims priority to U.S. Provisional Patent Application Ser. No. 62/480,903, filed on Apr. 3, 2017 and entitled “‘TRANSGENIC’MODEL PORTFOLIOS AND FUNDS”, which is incorporated herein by reference in its entirety.

### COPYRIGHT

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

The invention generally relates to financial systems, trading, and managing financial instruments. More specifically, the invention relates to methods and systems for creating model investment portfolios and funds comprised of tradable financial instruments (securities) found in a plurality of professionally managed accounts that have proven to deliver the greatest and most consistent returns, including by time period, risk level, and asset class; and to artificial-enhanced versions of them.

### RELATED ART

Advisors and automated tools are available to help investors construct investment portfolio strategies to meet changing financial objectives and market conditions. These portfolio strategies allocate assets across different classes of financial instruments, each representing varying degrees of expected risk and return. Often the most difficult aspect of portfolio construction and management is selecting specific holdings for each class.

Some investors seeking to outperform market averages can afford to engage registered investment advisors (RIAs) to help manage portfolios. An RIA is registered with the U.S. Securities and Exchange Commission (SEC) or one or more U.S. States to do business as a financial advisor. RIAs manage client portfolios as fiduciaries, and often are given discretionary authority to buy and sell financial instruments without a client's further consent. Based on Form ADV filed with the Securities and Exchange Commission, required by companies managing assets in excess of $25 million, there are more than 25 million “managed accounts” with discretionary trading authority (MAs).

By contrast, investors with more limited resources may only be able to access professional money management talent by investing in mutual funds. There are only a few thousand such mutual funds. In essence, each of these professionally managed mutual fund portfolios competes with more than 2500 times the number of professionally managed MAs. As such, compared to publicly available mutual funds, private MAs have more than 2500 times the opportunity to “beat the market.”

In an Apr. 12, 2017 article titled “Wall Street Rout: Indexes Beat Stockpickers 92% of the Time,” The Wall Street Journal stated: “Over the 15 years ending December 2016, 95.4% of U.S. mid-cap funds, 93.2% of U.S. small-cap funds and 92.2% of U.S. large-cap funds trailed their respective benchmarks.” Despite these miserable performance records, mutual funds extract approximately $100 billion annually in fees from investors. The invention allows anyone to access and leverage the much larger, and most proven, private MA talent through unique models and funds.

### BRIEF SUMMARY OF THE INVENTION

MA portfolios reflect the human intelligence of the professionals responsible for their constitution and evolution. The invention combines the most proven MA intelligence, and makes it publicly available to investors through model portfolios and funds; as well as artificial intelligence (AI) enhanced versions.

### Discovering the Best Professional Intelligence

The invention analyzes large numbers of existing MA histories over varying time periods, by risk level, and by asset class. MAs with the greatest and/or most consistent returns (Performance) by time period and risk level and/or asset class contain holdings that will be mirrored in the invention's respective model portfolios and funds (MPFs).

For example, the S&P 500 Health Care Index comprises those companies included in the S&P 500 that are classified as members of the Global Industry Classification Standard (GICS) healthcare sector. The present invention will examine MA histories for the presence of these companies. Where the holdings meet threshold conditions, such as absolute value and/or percent of portfolio value, Performance of the healthcare holdings in each such portfolio will be compared to others and the S&P 500 Health Care Index. An exemplary embodiment might only utilize MAs with +3 sigma (3σ) healthcare Performances of MAs examined, which are three standard deviations above the norm (top 0.0013; or 13% of 1%).

### Combining the Best Intelligence

Continuing the example above, for time period X across a large number of MAs with healthcare holdings, the best Performances are determined relative to the others and the S&P 500 Health Care Index. Since MPFs include holdings from multiple MAs, the invention determines optimal holdings in healthcare MPFs based on backtesting possible combinations of the best MA healthcare performances, using historical closing price information to determine what return, risk, and consistency would have been achieved.

For every 10,000 MA histories examined, only 13 would be 3σ Performers. Yet there would be six billion possible combinations of these 13 (13 factorial; or 13!) for each time period and weighting assumption (such as using the same relative weight for each 3σ Performance). There are more than a million any-date-to-any-date pairs over 6 years of trading, with nearly an infinite number of weighting possibilities for each pair. Through backtesting, the invention seeks optimally Performing combinations (OPCs) for each risk level and asset class within any desired time period.

This very “big data” intensive analytical effort can be approached using conventional brute force computational systems, and/or with self/deep-learning artificial intelligence (AI) algorithms to selectively narrow data sets and evaluate non-obvious combinations.

Combining multiple MA holdings create new Performance and risk profiles. For example, there was a period in time when an investor could purchase shares of Berkshire Hathaway, Inc., while also investing in Fidelity's Magellan Fund, essentially betting on legendary investors Warren Buffet and Peter Lynch. But there was no single investment offering available based on various combinations of both Buffet's and Lynch's holdings. Had possible combinations been backtested, new and different risk, return, and consistency profiles could have been calculated. The invention can determine any possible combination of any plurality of MAs, in whole or by asset class; each combination having a unique Performance and risk profile not previously available.

### MPFs Synchronize with Sub-Advising MAs

MAs, referred to as “sub-advising” when used in combination to form MPFs, continue to operate as before. The RIAs involved simply continue to manage the client accounts. When a sub-advising MA makes a trade, the sub-advised MPF will, as soon as possible after, update models and trade funds proportionally to maintain the relative MA weightings that define the MPF.

### MPFs—Best Active Management Possible at Passive Prices

A Mar. 30, 2017 Bloomberg article stated: “The evidence has piled up in recent years that the vast majority of active managers fail to beat the market net of their fees. A common reaction is that beating the market is too difficult and that it's therefore a waste of time and money to try. But just the opposite is true . . . the problem is not that active managers fail to outperform the market; it's that they keep that outperformance for themselves through high fees.”

Because any MPF trading activity which mirrors sub-advising MA trades is always helpful for the involved MAs and their advisors and investors, since an increase in the same activity (whether buying or selling) nudges the market in the desired direction, MPFs justify a lower cost passive-like pricing model for a higher value active trading performance. Sub-advisors don't need additional incentive to continue investing wisely for their clients (in exemplary implementations no one will even know who they are), and the cost of computer-trading MPFs can be lower than the cost of tracking an index (fewer trades). As such, a MPF investor might pay a fraction of the expected management fee for an active investment program that consistently beats an index having similar or greater risk.

### Making MPFs Available

MPFs as model portfolios can advise investors or financial professionals (“notify me when any instrument in this MPF trades”), interactively engage with advisors (“how would the model portfolio change if constrained to market decline scenarios only”) (Augmented Advisory™), or automatically trade positions in an investment account (“make this healthcare MPF X % of a portfolio”). Deploying MPFs as tradable funds, including mutual and/or exchange-traded funds (ETFs), or portions of funds, will make them available to the full investing public.

### Artificial Intelligence Enhanced MPFs

Artificial intelligence (AI) can potentially augment and enhance human intelligence OPCs, and be offered as separate model and fund choices. A Jun. 14, 2017 Wall Street Journal article illustrates an example:
“[Economists] downloaded all the 10-K and 10-Q filings with the Securities and Exchange Commission from 1994 through 2014 and used textual-analysis software to create a similarity score showing how the language in corporate filings differed one period to the next.
They then looked at stock performance following filings. The finding: Shares of companies that had significant changes did much worse than those of companies that didn't. This was particularly true when it came to changes in the risk factors section of 10-Ks.”
[A strategy of buying shares of companies with no significant risk-factor changes and betting against companies with major changes would have returned more than 22 percentage points more than the overall market annually.]
   AI algorithms, whether developed to be task-specific or machine/deep-learned, could examine such “research data” relating to OPC companies, altering and backtesting weighted holdings in the OPCs. Alongside non-AI models and funds (most proven jockeys), AI-augmented versions combining the very best human and artificial intelligence (most proven jockeys riding the best mathematical horses) could be offered as separate models and funds.

### BRIEF DESCRIPTION OF THE SEVERAL VIEWS OF THE DRAWINGS

FIG. 1 is a block diagram of a structure embodiment according to the present invention.

FIG. 2 is a schematic flow chart depicting the program flow of a software application in the structure of FIG. 1, according to one embodiment of the present invention.

FIG. 3 is a schematic flow chart depicting the program flow of a software application in the structure of FIG. 1, according to a more specific embodiment of the present invention.

### DETAILED DESCRIPTION OF THE INVENTION

An exemplary embodiment of the present invention is discussed in detail below. It should be understood that this specific implementation is done for illustration purposes. Other components and configurations may be used without departing from the spirit and scope of the present invention.

The presently described embodiment relates to investment model portfolio construction, public or private fund offerings based on those models, and artificial intelligence-enhanced versions of both the models and funds. Embodiments of the present technology include methods and computer systems for generating investment portfolio models and funds based on historical performances of professionally “managed accounts” (MAs).

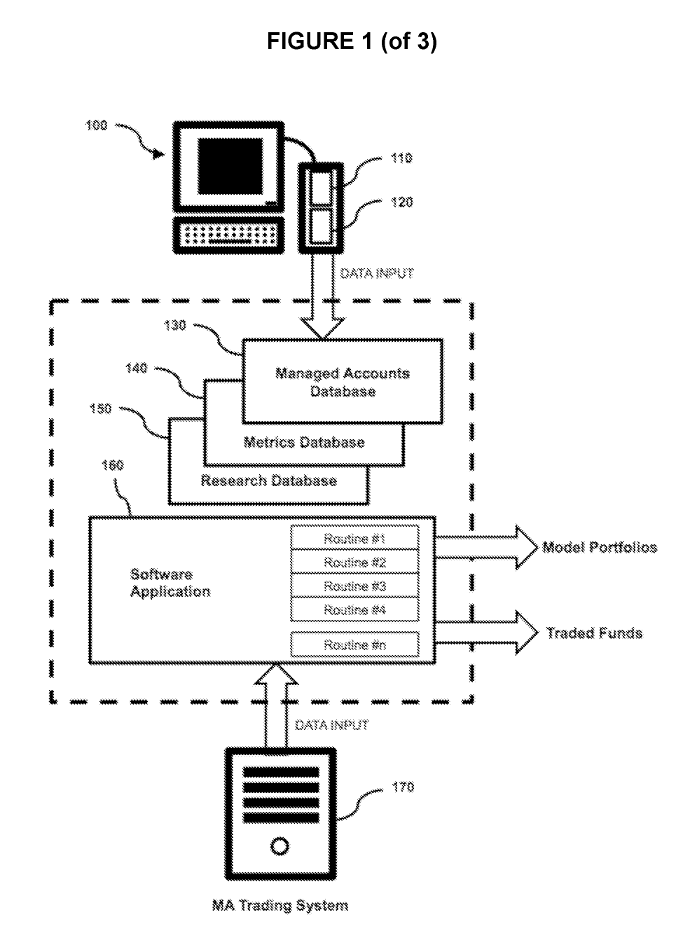

Referring to FIG. 1, MA database 130, metrics database 140, and research database 150 receive and store data using a computing system 100 (e.g., a conventional computer standing alone or connected to a server (not shown)). Computing system 100 comprises at least a processor 110 and a memory 120. Memory 120 contains MA database 130, metrics database 140, and research database 150, and software application 160 which comprises a plurality of instruction routines which are executed by processor 110 to carry out particular steps in the method of the presently described technology. External trading system 170 informs software application 160 when a security in a MPF MA is traded.

Processor 110 may be contained within a single computer system such as system 100, or distributed among multiple computer systems. Likewise, MA database 130, metrics database 140, and research database 150 may be contained within a single computer system such as system 100, or distributed among multiple computer systems. Software application 160 may incorporate application logic and instruction routines within a single application module or across multiple application modules, which may be contained in a single computer system such as system 100, or distributed among multiple computer systems.

Data may be downloaded from an internet server (not shown) into MA database 130, metrics database 140, and research database 150, or transferred from a local storage medium (not shown), for example. The data which is stored in MA database 130, metrics database 140, and research database 150 may include data for any time period.

In accordance with at least one embodiment of the present technology, the securities in MA database 130 include all initial securities holdings, plus purchases and sales, for each MA within a prescribed time period. The metrics database 140 includes information for each security in MA database 130, including asset classification, related dividends or interest, and daily closing prices for the prescribed time period, as well as benchmark and statistical information to compare and/or compute various performance metrics. The research database 150 includes information for each security in MA database 130, including governmental filings and company related news. Software application 160 utilizes MA database 130 and metrics database 140 to compute daily values, and changes in values, for each security held in each MA for each desired time period. Software application 160 further computes return, risk, and consistency profiles for each MA, and MA asset class, in MA database 130 within the prescribed time period. Software application 160 also backtests various combinations of MAs and MA asset classes, and updates MPFs based on MA trade information received from trading system 170.

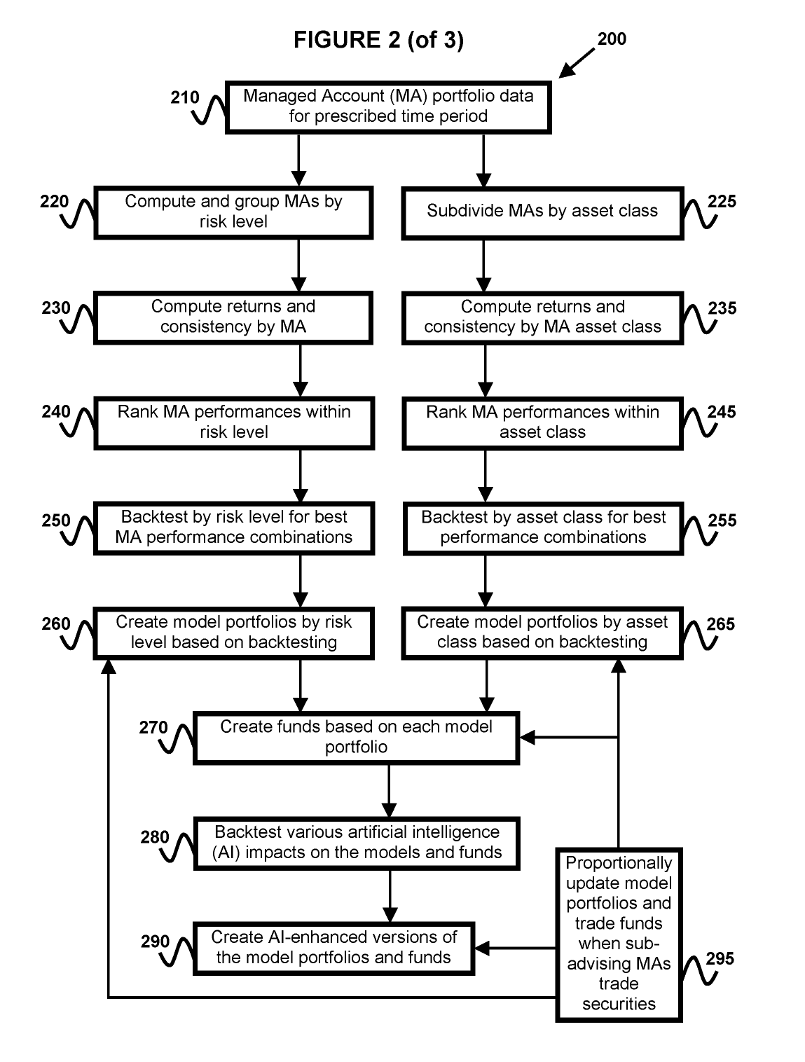

Referring again to FIG. 1, software application 160 is executed by processor 110 in order to carry out all or some of program flow 200, as shown in FIG. 2, in accordance with one embodiment of the present technology.

Referring to FIG. 2, in step 220 of flow 200, for a prescribed time period software application 160 computes and groups MAs in 210 by risk level. In step 230 of flow 200, software application 160 computes returns and consistency performance for each MA. In step 240 of flow 200, software application 160 identifies and ranks MA performances within each risk level. In step 250 of flow 200, software application 160 backtests various combinations and weightings of MA performances ranked in step 240 to determine the sub-advising MAs that will be mirrored in model portfolios for each risk level. In step 260 of flow 200, model portfolios for each risk level are created from the highest performing combinations identified in step 250 backtesting.

Separately, in step 225 of flow 200, for a prescribed time period software application 160 subdivides MA holdings in 210 by asset classes. In step 235 of flow 200, software application 160 computes returns and consistency performance for each MA asset class. In step 245 of flow 200, software application 160 identifies and ranks MA performances within each asset class. In step 255 of flow 200, software application 160 backtests various combinations and weightings of the MA performances ranked in step 245 to determine the sub-advising sub-divided MAs that will be mirrored in model portfolios for each asset class. In step 265 of flow 200, model portfolios for each asset class are created from the highest performing combinations identified in step 255 backtesting.

Traded funds are created in step 270 of flow 200 that contain the same securities holdings in the same proportions as model portfolios from steps 260 and 265. Using research database 150, artificial intelligence algorithms in step 280 of flow 200 are applied to MPFs from steps 260 and 265 and backtested to determine any additional performance gains that would have been achieved had alterations in holdings or weightings been made during the specified period. In step 290 of flow 200, superior outcomes determined in step 280 will create AI-enhanced versions of the MPFs from steps 260 and 265. In step 295 of flow 200, MA trading system 170 communicates any purchase or sale transactions in sub-advising MAs so model portfolios can be proportionally updated and funds proportionally traded.

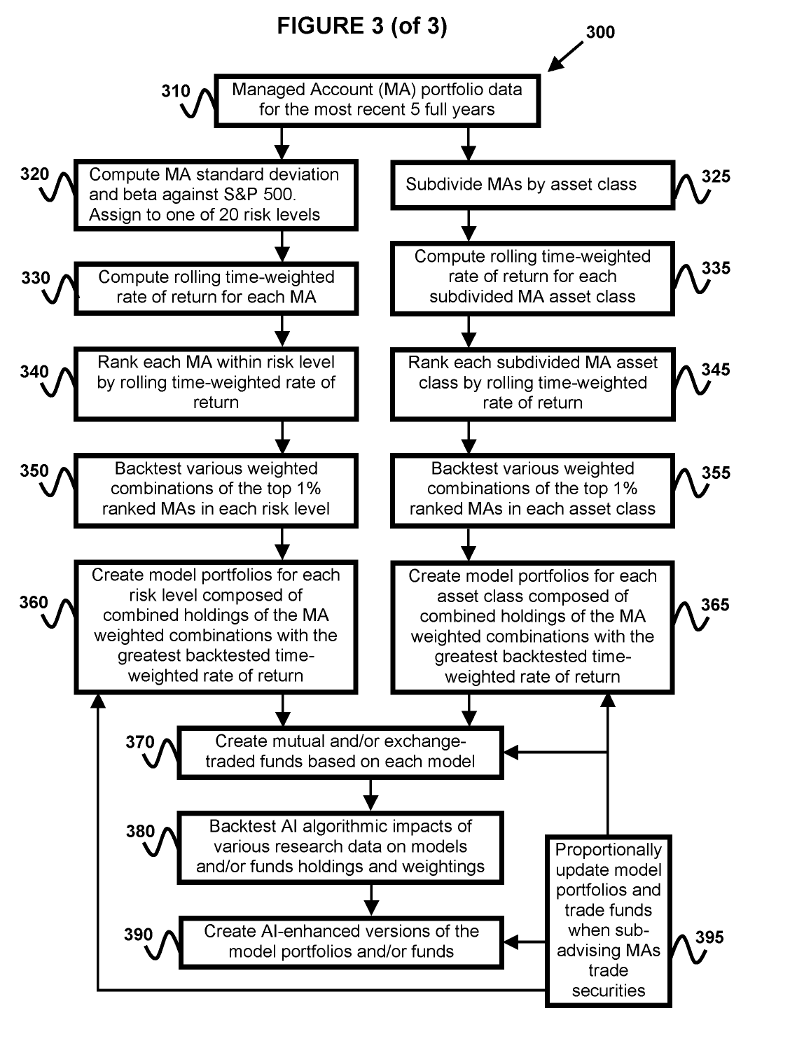

FIG. 3 shows a more specific embodiment of the present invention. Referring again to FIG. 1, software application 160 is executed by processor 110 in order to carry out program flow 300, as shown in FIG. 3.

Referring to FIG. 3, in step 320 of flow 300, using the most recent five full years of managed account histories from step 310, application 160 computes and assigns MAs in 310 to one of twenty risk levels based on portfolio beta (historical risk) and standard deviation (volatility/consistency). In step 330 of flow 300, software application 160 computes rolling returns and consistency performance for each MA. In step 340 of flow 300, software application 160 identifies and ranks MA performances within each risk level based on rolling time-weighted rate of returns. In step 350 of flow 300, software application 160 backtests various combinations and weightings of MA performances ranked in step 340 to determine the MAs that will be mirrored in model portfolios for each risk level. In step 360 of flow 300, model portfolios for each risk level are created from the highest performing combinations identified in step 350 backtesting.

Separately, in step 325 of flow 300, using the most recent five full years of managed account histories from step 310 software application 160 subdivides MA holdings in 310 by asset classes. In step 335 of flow 300, software application 160 computes returns and consistency performance for each MA asset class. In step 345 of flow 300, software application 160 identifies and ranks MA performances within each asset class. In step 355 of flow 300, software application 160 backtests various combinations and weightings of the MA performances ranked in step 345 to determine the MAs that will be mirrored in model portfolios for each asset class. In step 365 of flow 300, model portfolios for each asset class are created from the highest performing combinations identified in step 355 backtesting.

Publicly accessible funds are created in step 370 of flow 300 that contain the same holdings in the same proportions as model portfolios from steps 360 and 365. Using research database 150, artificial intelligence algorithms in step 380 of flow 300 are applied to MPFs from steps 360 and 365 and backtested to determine any additional performance gains that would have been achieved had alterations in holdings or weightings been made during the specified period. In step 390 of flow 300, superior outcomes determined in step 380 will create AI-enhanced versions of the MPFs from steps 360 and 365. In step 395 of flow 300, MA trading system 170 communicates any purchase or sale transactions in sub-advising MAs so model portfolios can be proportionally updated and funds proportionally traded.

1. A computer-implemented method of a new and useful process for creating combined model investment portfolios based on holdings and trading in a plurality of discretionary accounts managed by Registered Investment Advisors comprising the new combination of steps of:
examining a plurality of discretionary account records having a history of purchases and sales, and assigning each account to a risk level category;
examining a plurality of discretionary account records having a history of purchases and sales, and assigning each security to an asset class category;
calculating time period return and consistency performance for each discretionary account, from any available holding date to any subsequent date;
calculating time period return and consistency performance for each discretionary account asset class, from any available holding date to any subsequent date;
ranking by time period a plurality of discretionary accounts from greatest to least by return, consistency, and combined return and consistency performances;
ranking by time period and asset class a plurality of discretionary account asset classes from greatest to least by return, consistency, and combined return and consistency performances;
backtesting by time period and varying weights, the highest ranked discretionary accounts by return, consistency, and combined return and consistency across a plurality of discretionary accounts, using brute force computational systems and/or self/deep-learning algorithms to determine optimal return and consistency performance combinations from the more than 10¹⁵⁷ possibilities per one hundred accounts;
backtesting by time period and varying weights, the highest ranked discretionary account asset classes by return, consistency, and combined return and consistency across a plurality of discretionary accounts, using brute force computational systems and/or self/deep-learning algorithms to determine optimal return and consistency performance combinations from the more than 10¹⁵⁷ possibilities per one hundred account asset classes;
creating risk level model portfolios for each risk level within time period, comprised of current holdings in a plurality of discretionary accounts which in combination represents the highest return, consistency, and combined return and consistency performances for each risk level;
creating asset class model portfolios for each asset class within time period, comprised of current asset class holdings in a plurality of discretionary accounts which in combination represents the highest return, consistency, and combined return and consistency performances for each asset class;
synchronizing each model portfolio with the plurality of discretionary accounts from which the model portfolio is created, such that when a purchase or sale is made in a discretionary account a proportional purchase or sale change to the model portfolio is made.

2. The computer-implemented method according to claim 1, wherein a user via a computer or communication device views a model portfolio.

3. The computer-implemented method according to claim 1, wherein a user via a computer or communication device views and compares the time period return, consistency, and combined return and consistency performance of an investment account or asset class in an investment account to the same time period risk level or asset class model portfolio.

4. The computer-implemented method according to claim 1, wherein a user via a computer or communication device requests notifications, based on conditions set by the user; when a change occurs in a time period risk level or asset class model portfolio.

5. The computer-implemented method according to claim 1, wherein a user via a computer or communication device requests purchases or sales such that a defined portion of an investment account mirrors a time period risk level or asset class model portfolio.

6. The computer-implemented method according to claim 1, wherein a user via a computer or communication device requests an automatic purchase or sale in a defined portion of an investment account based on a change in a time period risk level or asset class model portfolio.

7. The computer-implemented method according to claim 1, wherein a fund or portion of a fund mirrors a time period risk level or asset class model portfolio.

8. The computer-implemented method according to claim 1, wherein an automatic purchase or sale in a fund or portion of a fund is based on a change in a time period risk level or asset class model portfolio.

9. A computer-implemented method of a new and useful process for creating combined model investment portfolios based on holdings and trading in a plurality of discretionary accounts managed by Registered Investment Advisors comprising the new combination of steps of:
examining a plurality of discretionary account records having a history of purchases and sales, and assigning each account to a risk level category;
examining a plurality of discretionary account records having a history of purchases and sales, and assigning each security to an asset class category;
calculating time period return and consistency performance for each discretionary account, from any available holding date to any subsequent date;
calculating time period return and consistency performance for each discretionary account asset class, from any available holding date to any subsequent date;
ranking by time period a plurality of discretionary accounts from greatest to least by return, consistency, and combined return and consistency performances;
ranking by time period and asset class a plurality of discretionary account asset classes from greatest to least by return, consistency, and combined return and consistency performances;
backtesting by time period and varying weights, the highest ranked discretionary accounts by return, consistency, and combined return and consistency across a plurality of discretionary accounts, using brute force computational systems and/or self/deep-learning algorithms to determine optimal return and consistency performance combinations from the more than 10¹⁵⁷ possibilities per one hundred accounts;
backtesting by time period and varying weights, the highest ranked discretionary account asset classes by return, consistency, and combined return and consistency across a plurality of discretionary accounts, using brute force computational systems and/or self/deep-learning algorithms to determine optimal return and consistency performance combinations from the more than 10¹⁵⁷ possibilities per one hundred account asset classes;
creating risk level model portfolios for each risk level within time period, comprised of current holdings in a plurality of discretionary accounts which in combination represents the highest return, consistency, and combined return and consistency performances for each risk level;
creating asset class model portfolios for each asset class within time period, comprised of current asset class holdings in a plurality of discretionary accounts which in combination represents the highest return, consistency, and combined return and consistency performances for each asset class;
synchronizing each model portfolio with the plurality of discretionary accounts from which the model portfolio is created, such that when a purchase or sale is made in a discretionary account a proportional purchase or sale change to the model portfolio is made;
synchronizing each model portfolio based on subsequent artificial intelligence algorithms examining research data relating to holdings in the model portfolio.

10. The computer-implemented method according to claim 9, wherein a user via a computer or communication device views a model portfolio.

11. The computer-implemented method according to claim 9, wherein a user via a computer or communication device views and compares the time period return, consistency, and combined return and consistency performance of an investment account or asset class in an investment account to the same time period risk level or asset class model portfolio.

12. The computer-implemented method according to claim 9, wherein a user via a computer or communication device requests notifications, based on conditions set by the user; when a change occurs in a time period risk level or asset class model portfolio.

13. The computer-implemented method according to claim 9, wherein a user via a computer or communication device requests purchases or sales such that a defined portion of an investment account mirrors a time period risk level or asset class model portfolio.

14. The computer-implemented method according to claim 9, wherein a user via a computer or communication device requests an automatic purchase or sale in a defined portion of an investment account based on a change in a time period risk level or asset class model portfolio.

15. The computer-implemented method according to claim 9, wherein a fund or portion of a fund mirrors a time period risk level or asset class model portfolio.

16. The computer-implemented method according to claim 9, wherein an automatic purchase or sale in a fund or portion of a fund is based on a change in a time period risk level or asset class model portfolio.
